(19) United States
(12) Patent Application Publication
(10) Pub. No.: US 2004/0219929 A1
(43) Pub. Date: Nov. 4, 2004

(54) Radio communication device and method therefor

(76) Inventor: Edward Hatala, Devizes (GB)

Correspondence Address: MOTOROLA, INC., 1303 EAST ALGONQUIN ROAD, IL01/3RD, SCHAUMBURG, IL, 60196

(21) Appl. No.: 10/480,321

(22) PCT Filed: Apr. 22, 2002
(86) PCT No.: PCT/EP02/04432

(30) Foreign Application Priority Data
Jun. 15, 2001 (GB) 0114666.1

(51) Int. Cl. H04Q 7/20

(52) U.S. Cl. 455/456.1; 455/445; 455/427

(57) ABSTRACT

This invention relates to a method and apparatus for allocating a device address to a communication device and/or transmitting data to a communication device having a device address. A mobile communication device assigns itself a device address by performing the step of determining (301,303) the device address at least partly in response to a position of the mobile communication device. A base station (209) transmits data to the mobile communication device by performing the steps of determining (401) a target location area (211); and then transmitting (405) the data using the device address. The invention is particularly applicable to cellular communication systems.

### FIELD OF THE INVENTION

This invention relates to a method and apparatus for allocating a device address to a communication device and/or transmitting data to a communication device having a device address. The invention is particularly applicable, but not limited, to cellular communication systems.

### BACKGROUND OF THE INVENTION

Present day communications systems, both wireless and wire-line, have a requirement to transfer data between communications units. Data, in this context, includes speech and multimedia communication. Such data transfer needs to be effectively and efficiently provided for, in order to optimise use of limited communication resources.

For data to be transferred across communications networks, a communication unit addressing protocol is required. The communication units are generally allocated addresses that are read by communications equipment such as bridges, gateways and/or routers, in order to determine how to transfer the data to the addressed unit. The interconnection between networks is generally known as internetworking (or internet).

Networks are often divided into sub-networks, with protocols being set up to define a set of rules that allow the orderly exchange of information. Currently, the two most popular protocols used to transfer data in communications systems are: Transfer Control Protocol (TCP) and Internet Protocol (IP). In all but the simplest of communications systems, these two protocols often work as a complementary pair. The IP portion corresponds to data transfer in the network layer of the well-known OSI model and the TCP portion to data transfer in the transport layer of the OSI model. Their operation is transparent to the physical and data link layers and can thus be used on any of the standard cabling networks such as Ethernet, FDDI or token ring.

The Internet Protocol adds a data header on to the information passed from the transport layer. The resultant data packet is known as an Internet datagram. The header of the datagram contains information such as destination and source IP addresses, the version number of the IP protocol etc. An IP address is assigned to each node on the internet. It is used to identify the location of the network and any sub-networks.

The IP program running on each node knows the location of a gateway on the network, where the gateway links the interconnected networks. Data then passes from node to gateway through the Internet. If the data to be transmitted is particularly large, the Internet Protocol also facilitates fragmentation of the data into smaller units. When a datagram is being routed, or is being reassembled, errors can occur. When such errors occur, the node that detects the error, reports back to the source node.

When transmitted from the source node, each datagram is routed separately through the Internet and the received fragments are finally reassembled at the destination node, prior to forwarding the data to the respective communication unit. The TCP-IP version number helps gateways and nodes interpret the data packet correctly.

Each node using TCP-IP communications requires an IP address that is then matched to its token ring or Ethernet MAC address. The MAC address allows nodes on the same segment to communicate with each other. In order for nodes on a different network to communicate with one another, each node must be configured with an IP address.

Nodes on a TCP-IP network are either hosts or gateways. Any nodes that run application software, or are terminals (mobile communication devices), are defined as hosts. Any node which is able to route TCP-IP packets between networks is called a TCP/IP gateway node. This node must have the necessary network controller boards to physically interface to other networks.

A typical IP address consists of two fields: the prefix field—a network number identifies the network associated with that particular address, and the suffix field—a host number identifies the particular host within that network. The IPv4 address is 32 bits long and can therefore theoretically address 232 (over four billion) physical networks. One problem, however, associated with using an IP address containing prefixes and suffixes lies in the decision on how large to make each field. If the prefix is too small, only a few networks will be able to be connected to the internet. However, if the prefix is made larger, then the suffix has to be reduced, which results in a network being able to support only a few hosts.

The present version of the internet protocol addressing scheme (IPv4) can accommodate a few very large networks or many small networks. In reality, a reasonable number of networks of various sizes are required to be supported. However, most organisations tend to have an IP addressing scheme arranged to accommodate a larger network than they generally need, to allow for future network expansion.

As a consequence, the current version of Internet Protocol (IPv4) has scarce addressing space and future versions are currently being developed. It is envisaged that each Public Land Mobile Network (PLMN) will be unable to allocate a unique permanent IP address to each MS using IPv4. Moreover, even in the event that IPv6 were to be deployed in the future, many networks will still consist of legacy networks implementing IPv4.

An IP address can be defined in the form:

‘aaa’.‘bbb’.‘ccc’.‘ddd’;

where: ‘aaa’, ‘bbb’, ‘ccc’ and ‘ddd’ are integer values in the range 0 to 255.

On the Internet the ‘aaa’.‘bbb’.‘ccc’ part normally define the sub-network and the ‘ddd’ the host. Such numbering schemes are difficult to remember. Hence, symbolic names (often termed domain names) are frequently used instead of IP addresses to identify individual communication units.

Each individual network on the Internet has a host that runs a process called a domain name server (DNS). The DNS maintains a database called the directory information base (DIB) that contains directory information for that network. When a new host is added, the system manager adds its name and its associated IP address to the DIB. The host is than able to access the Internet.

Normally, the DNS server is reachable by all the hosts on the network via the IP transport protocol. Therefore the DNS protocol for performing address lookup can be carried over IP.

The directory network services on the Internet determine the IP address of the named destination user or application program. This has the advantage that users and application programs can move around the Internet and are not fixed to a particular node and/or IP address.

Due to the recent growth in communications, particularly in internet and wireless communications, there exists a need to provide TCP-IP data transfer techniques in a wireless communications domain.

An established harmonised cellular radio communication system is GSM (Global System for Mobile Communications). An enhancement to this cellular technology can be found in the Global Packet Radio System (GPRS), which provides packet switched technology on a basic cellular platform, such as GSM. A further harmonised wireless communications system currently being defined is the universal mobile telecommunication system (UMTS), which is intended to provide a harmonised standard under which cellular radio communications networks and systems will provide enhanced levels of interfacing and compatibility with other types of communications systems and networks, including fixed communications systems such as the Internet.

In a cellular communication system, each of the communication devices, including subscriber units, mobile station and mobile communication devices, communicates with typically a fixed base station. Communication from the communication device to the base station is known as uplink and communication from the base station to the communication device is known as downlink. The total coverage area of the system is divided into a number of separate cells, each predominantly covered by a single base station. The cells are typically geographically distinct with an overlapping coverage area with neighbouring cells. FIG. 1 illustrates a cellular communication system 100. In the system, a base station 101 communicates with a number of communication devices 103 over radio channels 105. In the cellular system, the base station 101 covers users within a certain geographical area 107, whereas other geographical areas 109, 111 are covered by other base stations 113, 115. Some overlap areas can be covered by more than one cell.

As a communication device moves from the coverage area of one cell to the coverage area of another cell, the communication link will change from being between the communication device and the base station of the first cell, to being between the communication device and the base station of the second cell. This is known as a handover. Specifically, some cells may lie completely within the coverage of other larger cells.

All base stations are interconnected by a fixed network. This fixed network comprises communication lines, switches, interfaces to other communication networks and various controllers required for operating the network. A call from a communication device is routed through the fixed network to the destination specific for this call. If the call is between two communication devices of the same communication system the call will be routed through the fixed network to the base station of the cell in which the other communication device currently is. A connection is thus established between the two serving cells through the fixed network. Alternatively, if the call is between a communication device and a telephone connected to the Public Switched Telephone Network (PSTN) the call is routed from the serving base station to the interface between the cellular mobile communication system and the PSTN. It is then routed from the interface to the telephone by the PSTN.

A cellular mobile communication system is allocated a frequency spectrum for the radio communication between the communication devices and the base stations. This spectrum must be shared between all communication devices simultaneously using the system.

Information to be transmitted across the Internet is packetised, with packet switching routes established between a source node and a destination node. Hence, GPRS and UMTS networks have been designed to accommodate packet switched data to facilitate Internet services, such as message service, information service, conversational service and casting service.

Most services are initiated and activated from UMTS terminals (mobile communication devices). However, some services may be initiated from an Internet node, for example an audio or video conferencing service, home automation notification, job dispatching and information broadcast. These latter types of services are generally referred to as Internet-initiated services.

In order to support these services, GPRS and UMTS mobile communication devices are seen and treated as stand-alone Internet hosts uniquely identified by a name or an address. In systems employing a limited number of addresses by which to identify individual communication units, a technique called dynamic addressing is used.

Dynamic addressing requires a pool of addresses to be maintained by an address allocation server, for example a Dynamic Host Configuration Protocol (DHCP) server. Whenever a host is connected to a network, a signalling process is performed between the host and DHCP server to assign an available IP address to the host. In order to do so, the host needs to send the DHCP server its unique ID. When the signalling process is de-activated, the IP address will be returned to the addressing pool and will wait to be assigned to other mobile communication devices.

If a communication device (MS) initiates an Internet connection, the DHCP server recognises the need to identify the MS and typically informs a domain name server (DNS) that a new Internet Protocol address assignment has occurred. Subsequently, the local DNS can then map the communication device's domain name to an Internet Protocol address allocated by the DHCP, and pass the address information to an Internet Host.

Due to the static nature of typical devices using IP, such as networked PCs and servers, DHCP has been widely used in the Intranet environment to allocate IP addresses dynamically to any hosts that are connected to a network.

However, it is clear that such an arrangement is unacceptable in a wireless domain when the communicating unit requiring an IP address, is not physically connected to the Internet. With such wireless technology, the communication device needs to have previously established a logical connection with the Internet, in order to have been allocated an IP address and access Internet services, information and applications. This logical connection is generally referred to as a packet data protocol (PDP) context.

Furthermore, as the wireless communications units will not be permanently connected to the Internet, there will be many occasions when the MS will be in a mode where no PDP context with the Internet has been established. In such cases, the Internet Host cannot transfer data to a particular domain name of the communication device until a corresponding IP address is allocated. Such a problematic scenario always occurs for Internet-initiated services when the MS has not previously accessed the network and been allocated (and maintained) an IP address from the DHCP.

In the 3rd Generation cellular Packet data Protocol (3GPP) “Technical Specification 23.060 v3.3.0 for UMTS; GPRS Service description; stage 2, April 2000”, currently being developed by 3GPP of which the European Telecommunications Standards Institute (ETSI) is a member, it is specified that a gateway can request the activation of a PDP context for a communication device, upon the gateway receiving a packet from a communication device that does not have a PDP Context established.

However, in the Technical Specification, there is no recognition of a desire to obtain, or for that matter an indication on how to obtain, an IP address for a MS in order to deliver the first packet of data in a case when the Internet Host initiates the service, particularly when the MS is identified by a domain name.

In summary, a problematic situation occurs when a wireless communications unit has not been allocated an IP address, and the Internet Host initiates a communication. Without having an IP address allocated to the MS, a local DNS server has no means of relating the MS's address (Domain Name or other), as identified by the Internet Host, to a MS's IP address.

Furthermore, in a wireless cellular mobile communication systems the mobile communication devices are not static move between locations. Hence, when an Internet Host initiates a communication (a push service) it is necessary to first determine the location of the target mobile communication device in order to direct the transmissions to this location. Furthermore, if a broadcast message is to be transmitted it is necessary to determine the location for all recipients of the broadcast message. Conversely, if communication to mobile communication devices within a given area is desired, it is necessary to first identify mobile communication devices in this area, determine their IP address and consequently transmit to mobile communication devices using this identity.

As a result, a need exists to provide a method and apparatus for allocating a device address to a communication device and/or transmitting data to a communication device having a device address, wherein at least some of the above mentioned disadvantage(s) may be alleviated.

### SUMMARY OF THE INVENTION

Accordingly there is provided a method of assigning a device address to a mobile communication device in a radio communication system comprising the step of determining the device address at least partly in response to a position of the mobile communication device.

According to a second aspect of the invention, there is provided a method of transmitting data to a communication device comprising the steps of determining a target location area; determining a device address at least partly in response to the target location area; transmitting the data using the device address.

According to a third aspect of the invention, there is provided a radio communication device comprising means for determining a device address at least partly in response to a position of the radio communication device.

According to a fourth aspect of the invention, there is provided a radio communication device comprising means for determining a target location area; means for determining a device address at least partly in response to the target location area; means for transmitting the data using the device address.

According to a feature of the invention there is preferably a unique relationship between the device address and the target location area and vice versa. According to a further feature of the invention, the device address is preferably an Internet Protocol address and the radio communication system is a cellular communication system.

The invention provides a number of advantages including enabling independent assignment of device addresses to communication devices. It also provides a simple system for assigning and transmitting using device addresses associated with a location area. Hence, identification and targeting of specific communication devices in a specific location area can easily be accomplished.

### BRIEF DESCRIPTION OF THE DRAWINGS

An embodiment of the present invention is described below, by way of example only, with reference to the Drawings, in which:

FIG. 1 is an illustration of a cellular communication system according to prior art;

FIG. 2 is an illustration of a scenario in which the embodiment of the invention may be applied;

FIG. 3 illustrates a flow chart for a method of assigning a device address to a communication device in accordance with an embodiment of the invention;

FIG. 4 illustrates a flow chart for a method of transmitting data to a communication device in accordance with an embodiment of the invention.

### DETAILED DESCRIPTION OF A PREFERRED EMBODIMENT

The following description focuses on an embodiment compliant with a UMTS cellular communication network using Internet Protocol device addressing but it will be apparent that the invention is not limited to this application. For example, the invention is equally applicable to GPRS systems and GPRS device addressing.

In accordance with an embodiment of the invention, a relationship between the geographical position of a communication device and a device address of that communication device is defined. In the simplest form, the device address may be given as the longitude and latitude of the position of the communication device at an appropriate resolution.

In this simple embodiment, a mobile communication device will continuously perform position determination and determine its device address as the longitude and latitude resulting from that position determination. A base station (node B) transmitting to mobile communication devices in a specific location area will transmit using the longitude and latitude to identify the mobile communication device.

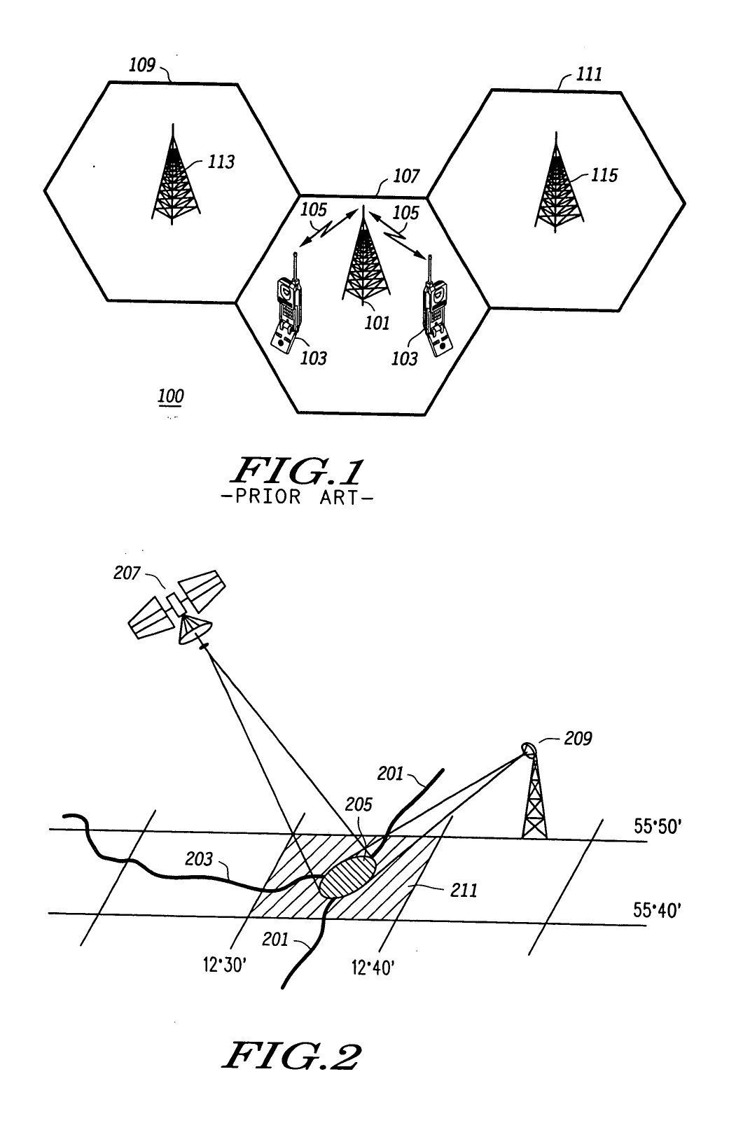

FIG. 2 shows a scenario in which the embodiment of the invention may be applied. In FIG. 2 two roads 201,203 traverse a geographical area and intersect in a road junction. A traffic accident has occurred at this junction resulting in a road accident area 205. A communication device within the road accident area 205 is receiving signals from a Global Positioning Satellite (GPS) 207 and determines a location based on these signals as is well known in the art. Based on the determined location, the communication device assigns itself the device address corresponding to the determined latitude and longitude—in the example the communication device is positioned at a latitude of 55°45′ N and a longitude of 12°34′ E. Using a granularity of 10′ the communication device accordingly assigns itself the device address of 554123.

The geographical area shown in FIG. 2 is covered by a base station 209. The emergency services may provide information to the operator of the network to be transmitted to communication devices within or near the accident area 205. Consequently, a target location area is determined that will encompass the location area to which the information must be sent—in the example given this will be the area 211 delimited by the latitudes 55°40′ and 55°50′ and the longitudes 12°30′ and 12°40′. Accordingly the device address to be transmitted to is determined as 554123. The messages are subsequently transmitted by the base station 209 using the device address of 554123.

The communication device will continuously receive messages from the base station 209 and upon detecting a message having a device address identical to the address it has assigned itself it will proceed to receive the entire message and output this to the user in an appropriate format such as e.g. a text or audio message. In the described embodiment it is thus possible to direct messages from the base station to communication devices in a target location area by each unit independently determining device addresses in response to the location of the mobile communication device and the target location area There is thus no need for a registration of device addresses or communication of device addresses over the radio link.

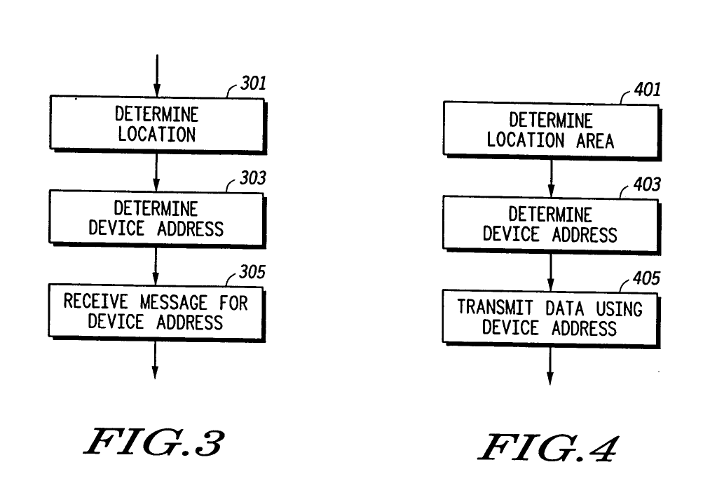

In a preferred embodiment of the invention, the device address is determined as an Internet Protocol IP address in response to both the location of the communication device and the network address of the transmitting base station. This embodiment will be described with reference to FIG. 3, which illustrates a method of assigning the device address to a communication device, and FIG. 4 which illustrates method of transmitting data to the communication device.

In step 301, a position of the communication device is determined. In the preferred embodiment the current position of the communication device is determined. It will be apparent that the position can be determined by any known method but in the preferred embodiment the communication device comprise a GPS receiver, which can determine the position from receipt of GPS satellite signals. Alternative methods include determining the position from measurements of the received signals from three or more base station, or the user manually inputting the current location.

The position can be determined in any suitable format such as e.g. in longitude/latitude or a grid reference value.

In step 303, a device address is determined from the position determined in step 301. In the preferred embodiment, the device address is an IP address derived from the position of the communication device. However, it will be clear that the device address may be any address suitable for identifying the communication device such as for example a phone number or a GPRS address.

The IP address is in the preferred embodiment determined in response to the position of the communication device as well as the network address of the serving base station.

The communication device identifies the serving base station by detecting a pilot signal transmitted from the base station. It then determines a subset of the IP address from this identification by using locally stored information relating the pilot identity to an IP address subset. Alternatively, the base station may directly broadcast an IP address subset allocated to it. An IP address defined in the form:

‘aaa’.‘bbb’.‘ccc’.‘ddd’;

will thus have the subset of ‘aaa’, ‘bbb’, and ‘ccc’ allocated to identify the specific base station. Hence from the pilot transmission the communication device may determine the ‘aaa’, ‘bbb’ and ‘ccc’ part of the IP address.

The ddd part of the IP address is in this embodiment allocated in response to the communication device's location in the cell. The cell is thus divided into a number of location areas and the communication device determines which location area it is in based on the position determination, and allocates a ddd part of the IP address accordingly. By combining the subset determined in response to the network address of the base station and the part determined in response to the location within the cell, a full IP address is determined.

An advantage of this approach is that routing of messages within the fixed network is possible considering only the ‘aaa’, ‘bbb’, and ‘ccc’ part of the address whereas the base station can control radio transmission in response to only the ‘ddd’ part of the address. For example, the ‘ddd’ part of address may directly relate to a transmission angle and distance from the base station thereby directly translating into a desired transmission pattern for a beam form antenna.

In an alternative embodiment, the IP address is determined based only on the location. In this embodiment, a given geographical area is divided into a number of IP location areas and each IP location area is allocated a specific IP address.

A communication device may contain a look up table relating each location area to the corresponding IP address. Assignment of the IP address is thus performed by the communication device determining the location and using this location to access the local look up table for determining the IP address.

It will be clear that any relationship between the location and the resulting device address is possible and that the technique is not limited to IP addresses only.

Preferably each location area corresponds to one specific IP address but alternatively a plurality of location areas (or entries in the look up table) may result in the same device address. In one embodiment this can be used for device addresses covering differently sized location areas (for example more IP addresses may be allocated per square mile in an urban area than in a rural area). In a different embodiment, the same device address can be allocated to geographically distinct areas such that communication devices in two or more separate location areas are addressed by the same device address. As an example, this can be of benefit in addressing communication devices of one company operating two or more distinct sites.

Thus in the preferred embodiment there is a unique relationship between a given location area and the corresponding device address. Furthermore, in the preferred embodiment there is a unique relationship between the device address and a location area such that if a device address is known a location area of the communication device can be unambiguously determined.

Once a communication device has assigned itself a device address, it will listen for any messages addressed to that device address. In the preferred embodiment, communication is by data packets comprising a header with each header comprising the device address.

The communication device will receive all packets transmitted on a given channel and will decode and demodulate at least the header part of each packet. If any packets contain the device address it has assigned itself, the communication device will continue to demodulate and in this case decode the entire data packet. The decoded data will then be output to the user in a suitable form—for example as a warning signal, a text message or a speech signal.

The method shown in FIG. 3 is preferably performed independently in the communication device. The assignment of the device address thus does not require any communication between a base station and a communication device and therefore the communication device may specifically be a receive only communication device having no transmission capability.

FIG. 4 illustrates a flow chart for a method of transmitting data to a communication device in accordance with an embodiment of the invention. The method is preferably performed by a base station but alternatively some or all of the steps may be performed in other network elements, in the communication device or may be distributed between elements.

In step 401 a target location area is determined. The target location area can be determined by any suitable means including being determined in response to the specific service or transmission, in response to the current loading of the cellular system, be predetermined or a location area can be manually entered by a user. In the simplest form the location area is simply determined by a user input specifying a longitude and latitude.

In more complex embodiments of the invention the location is determined in response to information of where a specific communication device or group of communication devices are or will be. In addition target location areas can be determined dependent on previous target location areas so that a group of location areas are targeted sequentially or in a random fashion.

In step 403, a device address is determined based on the target location areas. This step is equivalent to step 303 and the methods described for that step are equally applicable

In step 405, data is transmitted using the device address determined in step 403. Any suitable air interface, transmission protocol etc may be used but in the preferred embodiment transmission occurs by transmitting data packets with each data packet comprising a header containing the device address.

Specifically, the transmission may be omni-directionally but preferably the transmission uses adaptive antenna techniques to beam form in the direction of the target location area.

In some scenarios it is desirable to transmit to a group of communication devices. If all communication device's are within a single target location area they may each have been assigned (or have assigned themselves the same device address). In such a case all communication devices in that area are reached simply by transmitting using that device address.

However, if a group of communication devices covering more than one target area is to be transmitted to or alternatively if a target location area larger than the granularity of the device addressing is desired, the data can be transmitted using a plurality of device addresses. These device addresses may all be included in the header of a single data packet or separate data packets may be transmitted for different device addresses. In a different embodiment, the device address is organised such that a subset of the device address corresponds to a location area larger than and including the location area of the device address. In this embodiment a specific target location area may correspond to the IP address of

‘aaa’.‘bbb’.‘ccc’.‘ddd’

where each additional digit corresponds to a further division of the geographical area. In this embodiment the subset IP address of ‘aaa’.‘bbb’.‘ccc’.‘dd’ includes all target location areas having an IP address of ‘aaa’.‘bbb’.‘ccc’.‘dde’ for all possible values of e.

In this embodiment, transmission to a larger geographical areas can then be achieved by including the subset IP address in the data packet header. When receiving data packets, the communication devices will compare the decoded subset address with the assigned IP device address, and if the subsets match it will continue to process the data packet. In this way, the size of the targeted location area can be varied without increasing the size of the header.

An advantage of the embodiment described above is that it allows for the base stations and the communication device to independently determine device addresses in response to positions and locations areas. It therefore enables communication between base stations and communication devices in targeted locations without any exchange of information between the two.

However, in other embodiments of the invention the device address may be derived in the fixed network and communicated to the communication device over the air interface. This embodiment is preferred in cellular systems where location is determined in the fixed network by measurements of the uplink transmissions from the communication device, as is well known in the art. In this case, the network determines the location of the communication device. It may then communicate the determined position to the communication device over a radio link or air interface followed by the communication device determining the device address in response to this location. However, preferably the device address is also determined in the fixed network and the resultant device address is communicated to the communication device.

Alternatively, the communication device may contain means for determining the location such as a GPS receiver. It may then transmit the location information to the base station over a radio link followed by the device address being determined in the fixed network and communicated back to the communication device.

In accordance with one embodiment of the invention, the device address of a communication device is determined in the communication device and communicated to the fixed network over a radio link. Future transmissions from the fixed network to the communication device then use this device address.

In accordance with an embodiment of the invention, the position used in determining the device address is not the current position of the communication device but a future position of the communication device. In this scenario the route of the communication device is estimated and the device address is assigned in response to a position to which the communication device is moving. The future position can for example be estimated based on current position and speed, be manually entered by the user be based on the usual routes travelled by the communication device etc.

Equivalently in this embodiment the target location area to transmit to is not determined as the current location of a targeted communication device or group of communication devices, but is determined in response to a future position of the communication device.

Specifically, a number of target location areas may be selected to cover an expected route of the communication device. In this case at least a second device address corresponding to a second future position of the communication device is thus determined—either directly or indirectly by determining a second target location area.

In one embodiment of the invention, the communication devices will be assigned a device address according to the methods described above. However, the communication device will then retain this IP address even when moving from the location area corresponding to the IP address. The assignment of the IP address may be triggered by an event such as a message received from a base station. A specific example of this embodiment is where an emergency has occurred, and a control message is broadcast to all communication devices within the cell ordering them to assign themselves a semi permanent IP address. This address is retained until a message is received ordering a new IP address to be assigned. In this way the cellular communication system will be able to later address all communication devices which were in a given location area at a given time. They may therefore contact all communication devices potentially involved in the emergency or witnessing the emergency. In accordance with the embodiment, an ad-hoc network of all communication devices in a given location area at a given time is thereby formed.

Another example of a scenario where locking in the IP address is attractive is for example a sports event attracting a large crowd. If a device address assignment is triggered during the event, the cellular operator can after the event reach all spectators simply by using the device address corresponding to the location area of the sports arena. This is for example useful in advertising specific products or for example to download highlights of the event, after game statistics, interviews etc.

In a further embodiment all communication devices in a given location area are triggered to assign themselves a semi permanent device address. At a later time this device address is polled with all communication devices reporting back their current position. This provides information on the movement of a group of communication devices from a given location area and can be used in for example traffic management.

1. A method of assigning a device address to a mobile communication device in a radio communication system comprising the step of determining the device address at least partly in response to a position of the mobile communication device.

2. A method as claimed in claim 1 wherein there is a unique relationship between the target location area and the device address.

3. A method as claimed in claim 1 wherein there is a unique relationship between the device address and the target location area.

4. A method as claimed in claim 1 wherein the mobile communication device independently determines the device address based on a location estimate.

5. A method as claimed in claim 4 wherein the location estimate is generated by the mobile communication device.

6. A method of transmitting data to a mobile communication device comprising the steps of
determining a target location area;
determining a device address at least partly in response to the target location area;
transmitting the data using the device address.

7. A method as claimed in claim 6 wherein there is a unique relationship between the target location area and the device address.

8. A method as claimed in claim 6 wherein there is a unique relationship between the device address and the target location area.

9. A method as claimed in claim 6 comprising the step of transmitting data to a group of mobile communication devices by transmitting to the device address representing said target location area.

10. A method as claimed in claim 6 comprising the step of transmitting data to a group of mobile communication devices in a location by transmitting to a subset device address representing said location area.

11. A method as claimed in claim 1 wherein the device address is determined such that a subset of the device address corresponds to a location area larger than and including the location area of the device address.

12. A method as claimed in claim 1 wherein the step of determining the device address comprises the steps of:
determining a location of the device address in the mobile communication device;
the communication device transmitting over a transmit radio link the location to a device address allocation unit;
the mobile communication device receiving the device address from the allocation unit over a receive radio link.

13. A method as claimed in claim 1 wherein the step of determining the device address comprises the steps of:
determining a location of the device address in the mobile communication device;
determining the device address in the mobile communication device;
transmitting the device address to a transmitting device over a transmit radio link.

14. A method as claimed in claim 1 wherein the device address is determined in response to a future position of the mobile communication devices.

15. A method as claimed in claim 1 further comprising the step of determining at least a second device address corresponding to a second future position of the mobile communication device.

16. A method as claimed in claim 1 wherein the device address is an Internet Protocol address.

17. A method as claimed in claim 1 wherein the radio communication system is a cellular communication system.

18. A radio communication device comprising means for determining a device address at least partly in response to a position of the radio communication device.

19. A radio communication device as claimed in claim 18 wherein the radio communication device comprises means for independently determining the device address based on a location estimate.

20. A radio communication device as claimed in claim 18 comprising means for generating the location estimate.

21. A radio communication device as claimed in claim 18 wherein the radio communication device is a receive only radio communication device.

22. A radio communication device comprising
means for determining a target location area;
means for determining a device address at least partly in response to the target location area;
means for transmitting the data using the device address.

23. A radio communication device as claimed in claim 22 comprising means for transmitting data to a group of mobile communication devices in a location by transmitting to a subset device address representing said location area.

24. A radio communication device as claimed in claim 22 wherein the means for determining a device address are operable to determine the device address is determined such that a subset of the device address corresponds to a location area larger than and including the location area of the device address.

25. A radio communication device as claimed in claim 22 wherein the device address is an Internet Protocol address.

26. A radio communication device as claimed in claim 22 wherein the radio communication device is a cellular radio communication device.
